(19) United States
(12) Patent Application Publication
(10) Pub. No.: US 2026/0194855 A1
(43) Pub. Date: Jul. 9, 2026

(54) SHEET FEEDING APPARATUS AND IMAGE FORMING SYSTEM

(71) Applicant: KYOCERA Document Solutions Inc., Osaka (JP)

(72) Inventor: Satoshi ANDO, Osaka (JP)

(73) Assignee: KYOCERA Document Solutions Inc., Osaka (JP)

(21) Appl. No.: 19/439,878

(22) Filed: Jan. 5, 2026

(30) Foreign Application Priority Data
Jan. 8, 2025 (JP) 2025-002736

(51) Int. Cl. G03G 21/16; G03G 15/00

(52) U.S. Cl. CPC G03G 21/1647; G03G 15/6502; G03G 2221/1654

(57) ABSTRACT

A sheet feeding apparatus disposed beside an image forming apparatus and feeding a sheet as a recording medium to the image forming apparatus includes an apparatus body and a position adjustment mechanism. In the apparatus body, the sheet is stacked. A sheet feeding port through which the sheet is fed to the image forming apparatus is disposed in an opposing face of the apparatus body facing the image forming apparatus. The position adjustment mechanism is disposed at the opposing face of the apparatus body. The position adjustment mechanism can adjust the position, along the sheet width direction orthogonal to the sheet conveyance direction, of the apparatus body relative to the image forming apparatus.

### INCORPORATION BY REFERENCE

This application is based on and claims the benefit of priority from Japanese Patent Application No. 2025-002736 filed on January 8, 2025, the contents of which are hereby incorporated by reference.

### BACKGROUND

The present disclosure relates to a sheet feeding apparatus and an image forming system.

Some conventional image forming systems are configured with an image forming apparatus, such as a copier and a printer, and a sheet feeding apparatus. The sheet feeding apparatus can store several thousands of sheets (recording medium) inside it. The sheet feeding apparatus is disposed beside the image forming apparatus and can feed sheets to an image forming portion in the image forming apparatus.

### SUMMARY

According to one aspect of the present disclosure, a sheet feeding apparatus is disposed beside an image forming apparatus and feeds a sheet as a recording medium to the image forming apparatus. The sheet feeding apparatus includes an apparatus body and a position adjustment mechanism. In the apparatus body, the sheet is stacked. A sheet feeding port through which the sheet is fed to the image forming apparatus is disposed in an opposing face of the apparatus body facing the image forming apparatus. The position adjustment mechanism is disposed at the opposing face of the apparatus body. The position adjustment mechanism can adjust the position, along the sheet width direction orthogonal to the sheet conveyance direction, of the apparatus body relative to the image forming apparatus.

### BRIEF DESCRIPTION OF THE DRAWINGS

FIG. 1 is a schematic sectional front view of an image forming system according to one embodiment of the present disclosure.

FIG. 2 is a perspective view of a sheet feeding apparatus in FIG. 1.

FIG. 3 is an enlarged view of a lower part of an opposing face of the sheet feeding apparatus in FIG. 2 facing an image forming apparatus.

FIG. 4 is a perspective view of a first position adjustment mechanism of the sheet feeding apparatus in FIG. 3.

FIG. 5 is a perspective view of the opposing face of the sheet feeding apparatus in FIG. 2 facing the image forming apparatus.

FIG. 6 is an enlarged view of an upper part of the opposing face of the sheet feeding apparatus in FIG. 2 facing the image forming apparatus.

FIG. 7 is a perspective view of a second position adjustment mechanism in the sheet feeding apparatus in FIG. 5.

FIG. 8 is an enlarged view of a sensing portion in the second position adjustment mechanism in FIG. 6.

FIG. 9 is an enlarged view of the inside of the sensing portion in the second position adjustment mechanism in FIG. 8.

FIG. 10 is an enlarged view of the sensing portion in the second position adjustment mechanism in FIG. 8 and a sensing segment in the image forming apparatus to be inserted into the sensing portion.

FIG. 11 is an enlarged view of a front part of the second position adjustment mechanism in FIG. 6.

FIG. 12 is an enlarged view of a hook member in the second position adjustment mechanism in FIG. 11.

FIG. 13 is a perspective view, as seen from inside, of the second position adjustment mechanism in FIG. 7.

FIG. 14 is a perspective view of a lever member and a link member in the second position adjustment mechanism in FIG. 13.

FIG. 15 is an enlarged view of the hook member in the second position adjustment mechanism in FIG. 12 and a coupled portion in the image forming apparatus that couples to the hook member.

### DETAILED DESCRIPTION

An embodiment of the present disclosure will be described below with reference to the accompanying drawings. The description below is not meant as any limitation on the present disclosure.

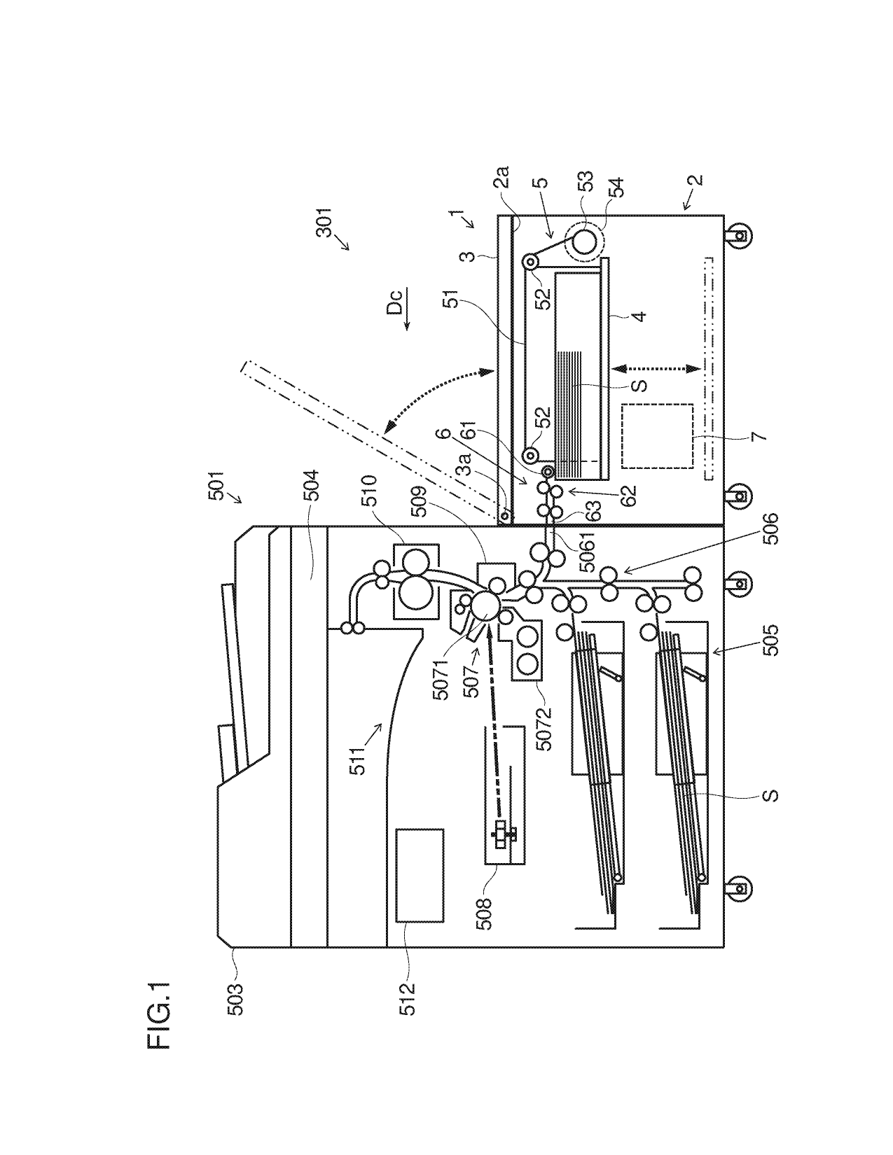

FIG. 1 is a schematic sectional front view of an image forming system 301 according to one embodiment. As shown in FIG. 1, the image forming system 301 includes an image forming apparatus 501 and a sheet feeding apparatus 1.

The image forming apparatus 501 can be what is generally called a multifunction peripheral for monochrome printing equipped with the functions of, for example, printing, scanning (image reading), facsimile transmission, and the like. Note that the image forming apparatus 501 can be, for example, an apparatus such as a copier or a printer, or a machine for color printing.

As shown in FIG. 1, the image forming apparatus 501 includes a document conveyance portion 503 and an image reading portion 504. The document conveyance portion 503 is placed on the top face of the body of the image forming apparatus 501. The image reading portion 504 is disposed below the document conveyance portion 503, inside the body of the image forming apparatus 501. The image of a document placed on the document conveyance portion 503 or the image of a document placed on a contact glass (not shown) on the top face of the image reading portion 504 is read by the image reading portion 504.

The image forming apparatus 501 further includes a sheet feeding portion 505, a sheet conveying portion 506, an image forming portion 507, an exposure portion 508, a transferring portion 509, a fixing portion 510, a sheet discharging portion 511, and an image formation control portion 512.

The sheet feeding portion 505 is disposed in a lower part of the image forming apparatus 501. The sheet feeding portion 505 stores a plurality of sheets (recording medium) S before image printing (image formation) and feeds out, while separating, one sheet S after another during printing.

The sheet conveying portion 506 extends along the top-bottom direction along a side wall of the image forming apparatus 501. The sheet conveying portion 506 conveys the sheet S fed out from the sheet feeding portion 505 to the transferring portion 509 and the fixing portion 510 and discharges the sheet S subjected to fixing to the sheet discharging portion 511. The sheet conveying portion 506 has a junction portion 5061. The junction portion 5061 is open in a side face of the image forming apparatus 501, in a region opposite the sheet feeding apparatus 1. The junction portion 5061 leads to a sheet conveyance path of the sheet feeding apparatus 1. The image forming apparatus 501 receives a sheet S fed out from the sheet feeding apparatus 1 via the junction portion 5061.

The image forming portion 507 is disposed above the sheet feeding portion 505. The image forming portion 507 includes a photosensitive drum 5071 and a development device 5072. The exposure portion 508 is disposed beside the image forming portion 507 and shines laser light controlled based on image data toward the image forming portion 507. In the image forming portion 507, the laser light shone from the exposure portion 508 forms an electrostatic latent image based on a document image on the outer circumferential surface of the photosensitive drum 5071. The development device 5072 feeds toner to the electrostatic latent image on the outer circumferential surface of the photosensitive drum 5071 to develop it to form a toner image (image).

The transferring portion 509 is disposed in the sheet conveyance path through the sheet conveying portion 506 adjacent to the photosensitive drum 5071. The transferring portion 509 transfers the toner image formed on the outer circumferential surface of the photosensitive drum 5071 to the sheet S

The fixing portion 510 is disposed above the transferring portion 509. The fixing portion 510 heats and presses the sheet S having the toner image transferred to it to fix the toner image to the sheet S.

The sheet discharging portion 511 is disposed below the image reading portion 504. The sheet S having the toner image fixed to it and having completed printing is conveyed to the sheet discharging portion 511 to be discharged. The sheet discharging portion 511 has an opening in its front face and permits the sheet after printing (print result) to be retrieved at the front side.

The image formation control portion 512 includes a CPU, an image processing portion, a storage portion along with other electronic circuits and components (none is shown). The CPU controls, based on programs and data for control stored in the storage portion, the operation of different components in the image forming apparatus 501 to perform processes relating to the functions of the image forming apparatus 501. The sheet feeding portion 505, the sheet conveying portion 506, the image forming portion 507, the exposure portion 508, the transferring portion 509, and the fixing portion 510 individually receive commands from the image formation control portion 512 and cooperate to perform printing (image formation) on the sheet S.

The storage portion is configured as a combination of a nonvolatile storage device (not shown) such as a program ROM (read-only memory) and a data ROM, and a volatile storage device (not shown) such as a RAM (random-access memory).

With the configuration described above, the image forming apparatus 501 forms an image on the sheet S.

The sheet feeding apparatus 1 is disposed to outside, to the side of, the image forming apparatus 501, adjacent to it. The sheet feeding apparatus 1 is detachably coupled to the side face of the image forming apparatus 501. Note that, the sheet feeding apparatus 1 can be coupled to, other than a multifunction peripheral, for example, an apparatus such as a copier or a printer in a similar manner. The sheet feeding apparatus 1 stores a plurality of sheets S before image formation (printing) in the image forming apparatus 501 and feeds out, while separating, one sheet S after another to feed them to the image forming apparatus 501.

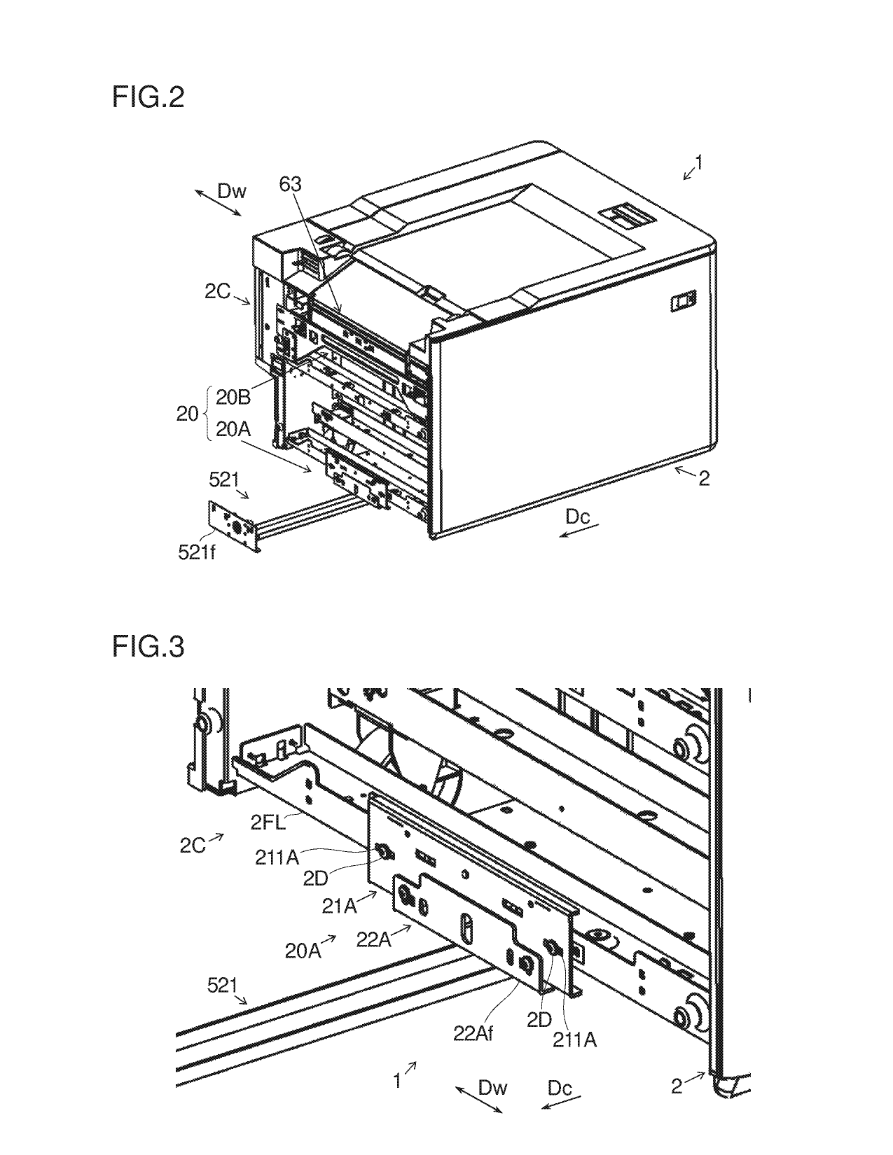

Next, the configuration of the sheet feeding apparatus 1 will be described. FIG. 2 is a perspective view of the sheet feeding apparatus 1 in FIG. 1. Note that, in the following description of the sheet feeding apparatus 1, the direction from the right side toward the left side in FIG. 1 is referred to as “sheet conveyance direction” in the sheet feeding apparatus 1 and is indicated by arrowed line Dc in FIG. 1 and the following figures. The direction orthogonal to the sheet conveyance direction Dc is referred to as “sheet width direction” and this is the front-rear direction with respect to the image forming apparatus 501 and the sheet feeding apparatus 1, that is, the near-far direction with respect to the plane of FIG. 1, and is indicated by arrowed line Dw in FIG. 2 and the following figures.

As shown in FIGS. 1 and 2, the sheet feeding apparatus 1 includes an apparatus body 2, a cover member 3, a sheet stacking tray 4, an ascent/descent driving portion 5, a sheet feeding portion 6, and a conveyance control portion 7.

The apparatus body 2 is formed substantially in a rectangular parallelepiped shape and has a storage space that can store several thousands of sheets S inside it. The apparatus body 2 has inside it a sheet stacking tray 4, an ascent/descent driving portion 5, and a sheet feeding portion 6. The apparatus body 2 has an opening portion 2a in its top face. The opening portion 2a serves as a supply port for sheets S to the sheet feeding apparatus 1.

The cover member 3 is formed substantially in a flat plate form and is disposed on the opening portion 2a of the apparatus body 2. The cover member 3 is supported on the apparatus body 2 via a rotation shaft 3a provided in a downstream end part of the cover member 3 in the sheet conveyance direction Dc and extending along the sheet width direction Dw. The cover member 3 can swing about the axis of the rotation shaft 3a to open and close relative to the opening portion 2a of the apparatus body 2.

The sheet stacking tray 4 is formed substantially in a horizontally extending flat plate form substantially in a rectangular shape and is disposed in the apparatus body 2. The sheet stacking tray 4 is attached to a guide member (not shown) extending along the top-bottom direction and can move along the top-bottom direction. In other words, the sheet stacking tray 4 is supported so that it can ascend and descend in the apparatus body 2. To the top face of the sheet stacking tray 4, sheets S are stacked; that is, inside the apparatus body 2, sheets S are stacked.

The ascent/descent driving portion 5 is disposed in the apparatus body 2. The ascent/descent driving portion 5 includes a plurality of wires 51, a plurality of relay pulleys 52, a reeling pulley 53, and a driving source 54.

In this embodiment, the ascent/descent driving portion 5 has, for example, four wires 51. Two of the four wires 51 are disposed in each of opposite end parts of the sheet stacking tray 4 along the sheet width direction Dw. One ends of the four wires 51 are connected to the sheet stacking tray 4 at four places respectively, namely in its opposite end parts along the sheet width direction Dw in each of its upstream and downstream parts along the sheet conveyance direction Dc, that is, to near the four corners of the sheet stacking tray 4 substantially in a rectangular shape. The other ends of the four wires 51 are connected to the reeling pulley 53.

The relay pulleys 52 are disposed above the sheet stacking tray 4, in each of opposite end parts of it along the sheet width direction Dw. Specifically, the four relay pulleys 52 are disposed above connected portions where the four wires 51 are connected to the sheet stacking tray 4. The wires 51 are wound around the relay pulleys 52.

The reeling pulleys 53 are disposed one in each of opposite end parts of the sheet stacking tray 4 along the sheet width direction Dw. The reeling pulley 53 is connected to the driving source 54 configured with, for example, a motor. The reeling pulley 53 rotates either forward (clockwise in FIG. 1) or reverse (counterclockwise in FIG. 1) using a rotation driving force from the driving source 54.

In the ascent/descent driving portion 5, as the reeling pulley 53 is rotated forward by the driving source 54, the wires 51 are reeled in onto the reeling pulley 53 around its outer circumferential surface and thus the sheet stacking tray 4 ascends. On the other hand, in the ascent/descent driving portion 5, as the reeling pulley 53 is rotated reverse by the driving source 54, the wires 51 are reeled out off the reeling pulley 53 and thus the sheet stacking tray 4 descends. In this way, the ascent/descent driving portion 5 raises and lowers the sheet stacking tray 4. The operation of the ascent/descent driving portion 5 is controlled by the conveyance control portion 7.

The sheet feeding portion 6 is disposed in an upper part of the apparatus body 2. The sheet feeding portion 6 includes a pickup roller 61, a pair of conveyance rollers 62, and a sheet feeding port 63.

The pickup roller 61 is disposed above an upstream part of the sheet stacking tray 4 along the sheet conveyance direction Dc. The pickup roller 61 is disposed opposite the sheet stacking tray 4 along the top-bottom direction. The pickup roller 61 is in contact with the sheet S stacked on the sheet stacking tray 4 at a predetermined conveyance position along the top-bottom direction. The pair of conveyance rollers 62 is disposed downstream of the pickup roller 61 in the sheet conveyance direction Dc.

In a state where the sheet S stacked on the sheet stacking tray 4 is at the predetermined conveyance position, as the pickup roller 61 rotates, the sheet S is fed out toward the downstream in the sheet conveyance direction Dc. The sheet feeding portion 6 conveys the sheet S fed out by the pickup roller 61 from the sheet stacking tray 4 farther downstream in the sheet conveyance direction Dc with the pair of conveyance rollers 62. In this way, the sheet feeding portion 6 makes contact with the sheet S stacked at the predetermined conveyance position on the sheet stacking tray 4 to convey it to downstream in the sheet conveyance direction Dc.

The sheet feeding port 63 is open in an opposing face 2C of the apparatus body 2 that is its side face facing the image forming apparatus 501 and leads to the junction portion 5061 in the image forming apparatus 501. The sheet feeding apparatus 1 feeds the sheet S toward the image forming apparatus 501 via the sheet feeding port 63 in the sheet feeding portion 6. The operation of the sheet feeding portion 6 is controlled by the conveyance control portion 7.

The conveyance control portion 7 includes a CPU, a storage portion along with other electronic circuits and components (none is shown). The conveyance control portion 7 is communicably connected to the image formation control portion 512 in the image forming apparatus 501. The conveyance control portion 7 receives commands from the image formation control portion 512 and controls, using the CPU and based on programs and data for control stored in the storage portion, the operation of different components in the sheet feeding apparatus 1 to perform processes relating to the functions of the sheet feeding apparatus 1. The ascent/descent driving portion 5 and the sheet feeding portion 6 individually receive commands from the conveyance control portion 7 and cooperate to convey the sheet S.

Note that the functions of the conveyance control portion 7 can be assigned to the image formation control portion 512 in the image forming apparatus 501.

Next, the configuration of the apparatus body 2 of the sheet feeding apparatus 1 will be described in detail. As shown in FIG. 2, the apparatus body 2 includes a position adjustment mechanism 20. The position adjustment mechanism 20 is disposed in the opposing face 2C of the apparatus body 2 facing the image forming apparatus 501. The position adjustment mechanism 20 includes a first position adjustment mechanism 20A and a second position adjustment mechanism 20B.

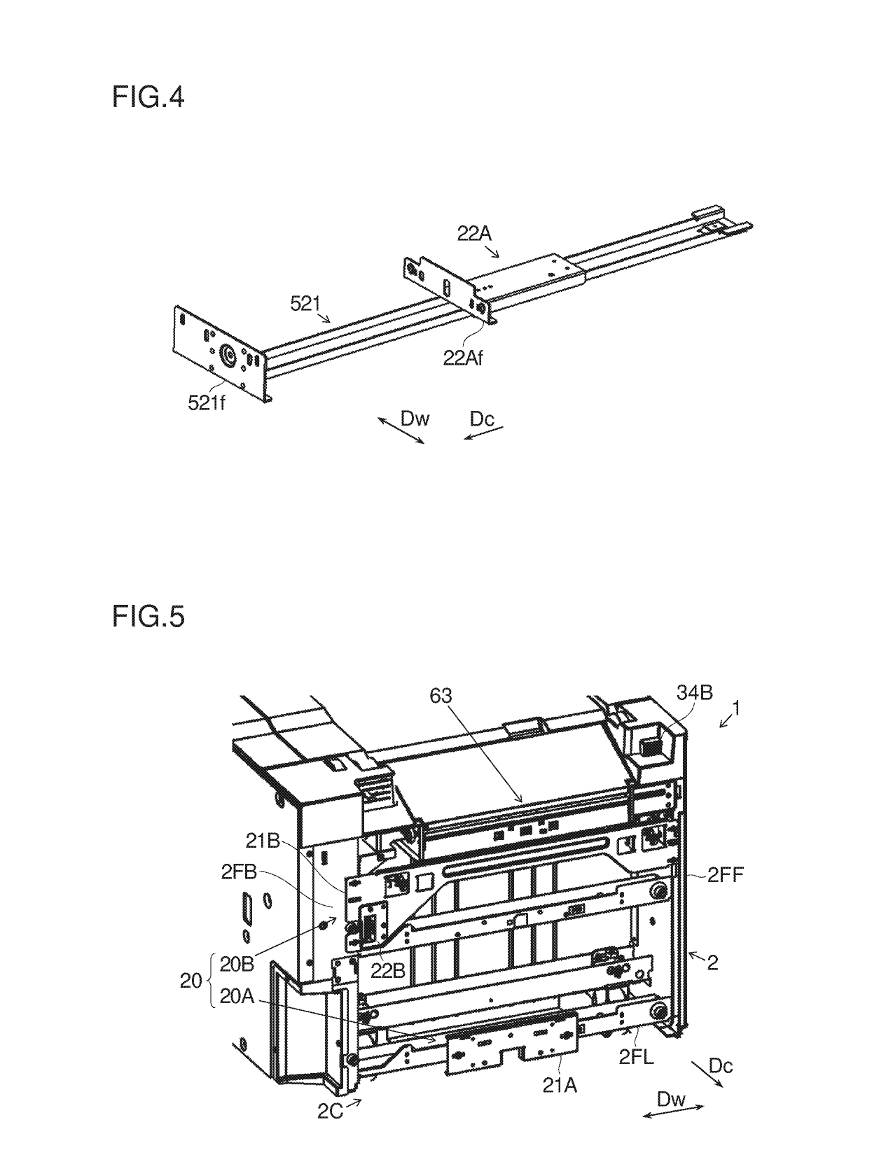

FIG. 3 is an enlarged view of a lower part of the opposing face 2C of the sheet feeding apparatus 1 in FIG. 2 facing the image forming apparatus 501. FIG. 4 is a perspective view of the first position adjustment mechanism 20A of the sheet feeding apparatus 1 in FIG. 3. The first position adjustment mechanism 20A is disposed in a bottom part of the apparatus body 2. The first position adjustment mechanism 20A includes a first positioning member 21A and a slide member 22A.

The first positioning member 21A is disposed along the opposing face 2C of the apparatus body 2. Specifically, the first positioning member 21A is disposed in a central part of the opposing face 2C along the sheet width direction Dw. Note that a lower part of the opposing face 2C of the apparatus body 2 is provided with a bottom frame 2FL extending along the sheet width direction Dw. The first positioning member 21A is fixed in a central part of the bottom frame 2FL along the sheet width direction Dw in the apparatus body 2. The first positioning member 21A is a plate-form member extending along the sheet width direction Dw and is formed of, for example, sheet metal.

The first positioning member 21A has first positioning holes 211A formed in opposite end parts of it along the sheet width direction Dw. The first positioning hole 211A has the shape of an elongate hole (in a rectangular shape) extending along the sheet width direction Dw and penetrates the first positioning member 21A along its thickness direction (the sheet conveyance direction Dc).

Screws 2D are fitted in parts of the bottom frame 2FL of the apparatus body 2 corresponding to the two first positioning holes 211A, respectively. The width (height), in the direction orthogonal to its longitudinal direction, of the first positioning hole 211A, which is an elongate hole extending along the sheet width direction Dw, is smaller than the diameter of the head of the screw 2D but is large enough to allow the threaded part of the screw 2D to pass through it. The screws 2D are screwed tight into the first positioning holes 211A.

The first positioning member 21A is fastened to the bottom frame 2FL with the screw 2D at the first positioning hole 211A formed in each of the opposite end parts of the first positioning member 21A along the sheet width direction Dw. Loosening the screw 2D allows the first positioning member 21A to move along the longitudinal direction of the first positioning hole 211A, that is, the sheet width direction Dw (the front-rear direction of the apparatus body 2), within the dimension of the elongate hole. Thus, it is possible to adjust the attachment position, along the sheet width direction Dw, of the first positioning member 21A with respect to the opposing face 2C of the apparatus body 2.

With respect to the first position adjustment mechanism 20A, the image forming apparatus 501 includes a long rail 521. The long rail 521 extends from the image forming apparatus 501 toward the sheet feeding apparatus 1 along the sheet conveyance direction Dc in the sheet feeding apparatus 1. The long rail 521 has a fixed portion 521f in its end part closer to the image forming apparatus 501 along its longitudinal direction (the sheet conveyance direction Dc in the sheet feeding apparatus 1). The fixed portion 521f is in a plate form extending along the sheet width direction Dw and is formed of, for example, sheet metal. The long rail 521 has its one end part along the sheet conveyance direction Dc connected (fixed) to the image forming apparatus 501 via the fixed portion 521f.

The long rail 521 is located below the first positioning member 21A of the sheet feeding apparatus 1 adjacent to the image forming apparatus 501, in a central part of the opposing face 2C along the sheet width direction Dw. The long rail 521 has a bottom face portion extending along the sheet conveyance direction Dc in the sheet feeding apparatus 1 and a pair of side face portions extending upward from the opposite ends of the bottom face portion along the sheet width direction Dw, and is in a trough form with a U-shaped section.

The slide member 22A is disposed between the first positioning member 21A and the long rail 521 along the top-bottom direction, in a central part of the opposing face 2C along the sheet width direction Dw. The slide member 22A has a top face portion extending along the sheet conveyance direction Dc and a pair of side face portions extending downward from the opposite ends of the top face portion along the sheet width direction Dw, and is in a trough form with a U-shaped section. The pair of side face portions of the slide member 22A are farther apart from each other than the pair of side face portions of the long rail 521. The slide member 22A is disposed astride the long rail 521. The slide member 22A is movable across the long rail 521 along the sheet conveyance direction Dc.

The slide member 22A has a fixed portion 22Af in one end part of it closer to the image forming apparatus 501 along its longitudinal direction (the sheet conveyance direction Dc). The fixed portion 22Af is in a plate form extending along the sheet width direction Dw and is formed of, for example, sheet metal. The slide member 22A has its one end part along the sheet conveyance direction Dc fixed to the first positioning member 21A via the fixed portion 22Af.

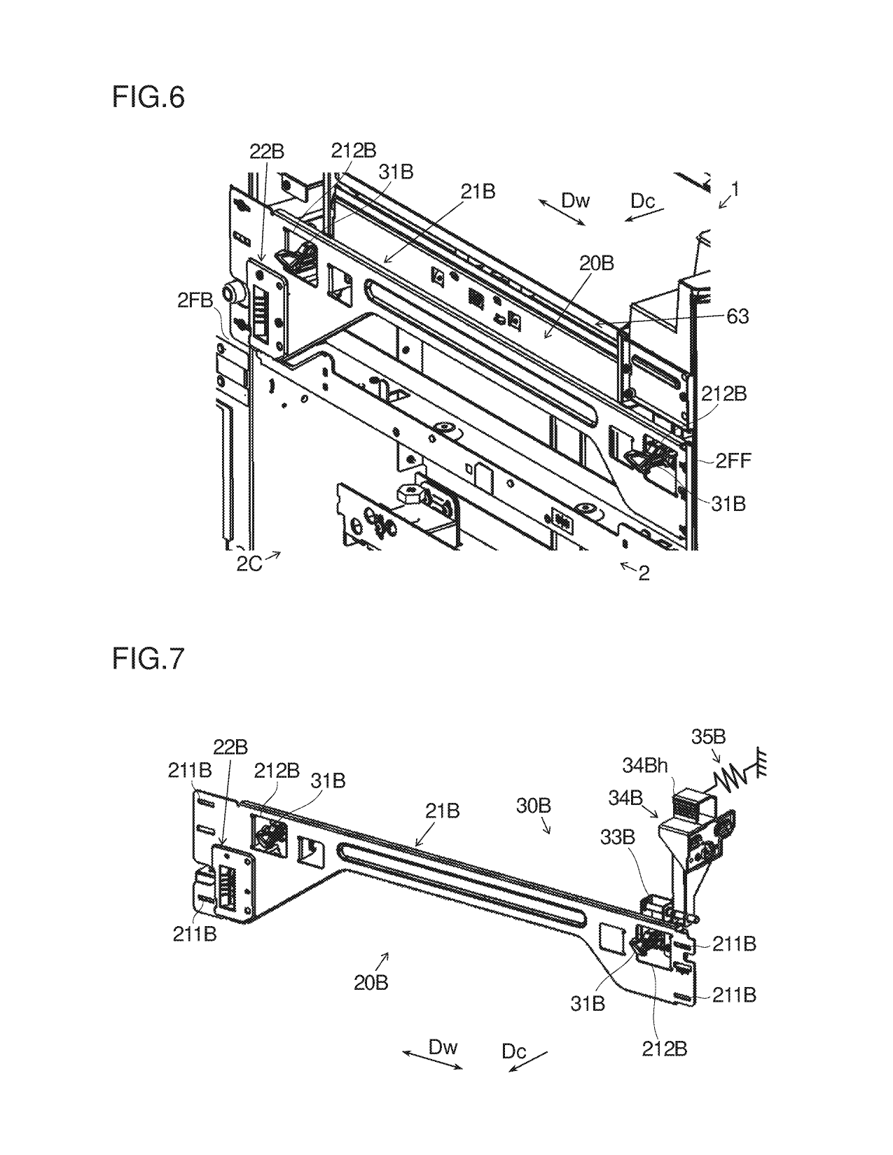

FIG. 5 is a perspective view of the opposing face 2C of the sheet feeding apparatus 1 in FIG. 2 facing the image forming apparatus 501. FIG. 6 is an enlarged view of an upper part of the opposing face 2C of the sheet feeding apparatus 1 in FIG. 2 facing the image forming apparatus 501. FIG. 7 is a perspective view of the second position adjustment mechanism 20B in the sheet feeding apparatus 1 in FIG. 5. The second position adjustment mechanism 20B is disposed above the first position adjustment mechanism 20A, near a central part of the opposing face 2C along the top-bottom direction. The second position adjustment mechanism 20B includes a second positioning member 21B, a sensing portion 22B, and a coupling mechanism 30B.

The second positioning member 21B is disposed along the opposing face 2C of the apparatus body 2. Specifically, the second positioning member 21B is a plate-form member extending substantially over an entire area of the opposing face 2C along the sheet width direction Dw and is formed of, for example, sheet metal. The second positioning member 21B stretches from a front frame 2FF to a rear frame 2FB of the apparatus body 2 and is fixed to them at its opposite ends along the sheet width direction Dw.

The second positioning member 21B has second positioning holes 211B formed in each of opposite end parts of it along the sheet width direction Dw. Two second positioning holes 211B are provided apart from each other along the top-bottom direction in each of the opposite end parts along the sheet width direction Dw. The second positioning hole 211B is formed as an elongate hole (in a rectangular shape) extending along the sheet width direction Dw and penetrates the second positioning member 21B along its thickness direction (the sheet conveyance direction Dc).

Screws 2E are fitted in parts of the front frame 2FF and the rear frame 2FB of the apparatus body 2 corresponding to the four second positioning holes 211B, respectively. The width (height), in the direction orthogonal to its longitudinal direction, of the second positioning hole 211B, which is an elongate hole extending along the sheet width direction Dw, is smaller than the diameter of the head of the screw 2E but is large enough to allow the threaded part of the screw 2E to pass through it. The screws 2E are screwed tight into the second positioning holes 211B.

The second positioning member 21B is fastened to the front frame 2FF and the rear frame 2FB with the screw 2E at the second positioning hole 211B formed in each of the opposite end parts of the second positioning member 21B along the sheet width direction Dw. Loosening the screw 2E allows the second positioning member 21B to move along the longitudinal direction of the second positioning hole 211B, that is, the sheet width direction Dw (the front-rear direction of the apparatus body 2), within the dimension of the elongate hole. Thus, it is possible to adjust the attachment position, along the sheet width direction Dw, of the second positioning member 21B with respect to the opposing face 2C of the apparatus body 2.

The sensing portion 22B is formed on the second positioning member 21B. Specifically, the sensing portion 22B is disposed, on the second positioning member 21B, a rear part of the opposing face 2C along the sheet width direction Dw (at left in FIGS. 5 and 6). The sensing portion 22B is disposed, with respect to the sheet width direction Dw, closer to the front of the sheet feeding apparatus 1 than the second positioning hole 211B adjacent to the rear frame 2FB (hereinafter, the front and rear sides with respect to the sheet feeding apparatus 1 are referred to simply as the front and rear sides respectively), below a hook member 31B in the coupling mechanism 30B, which will be described later.

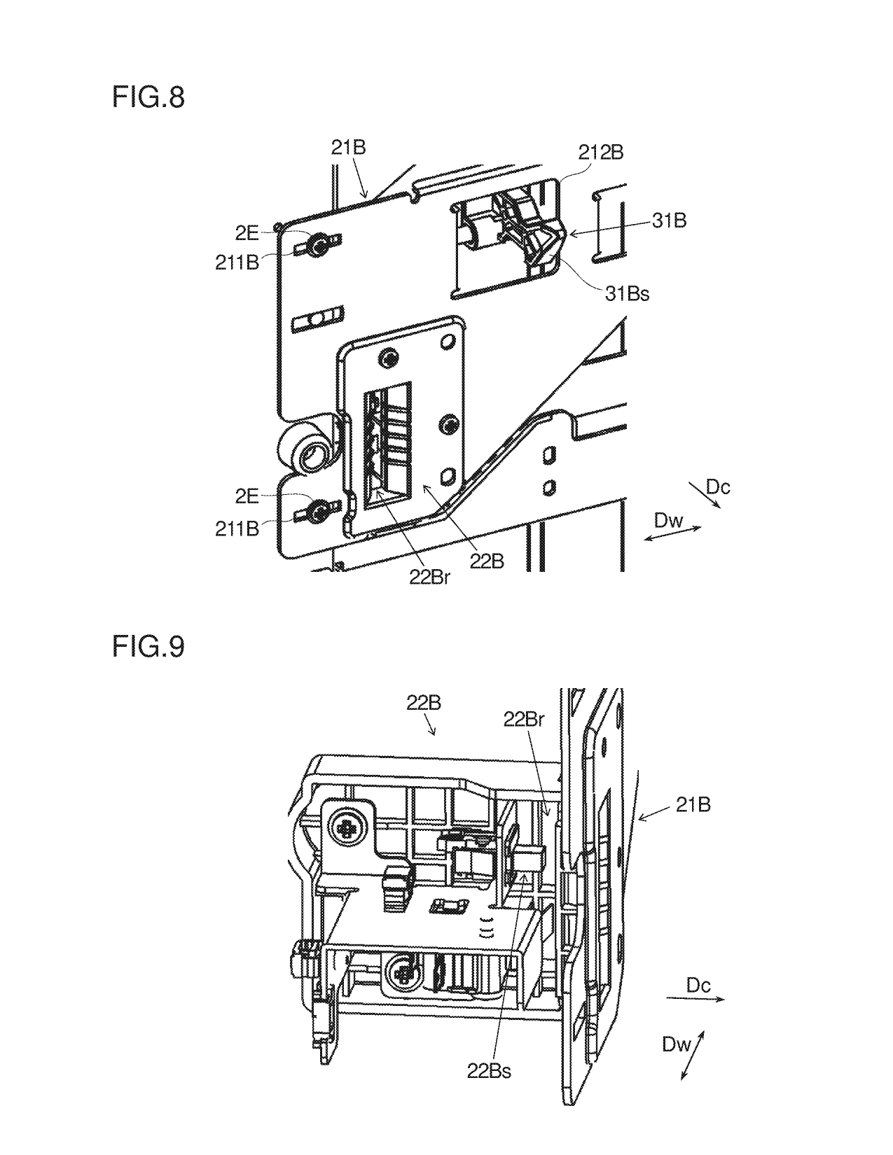

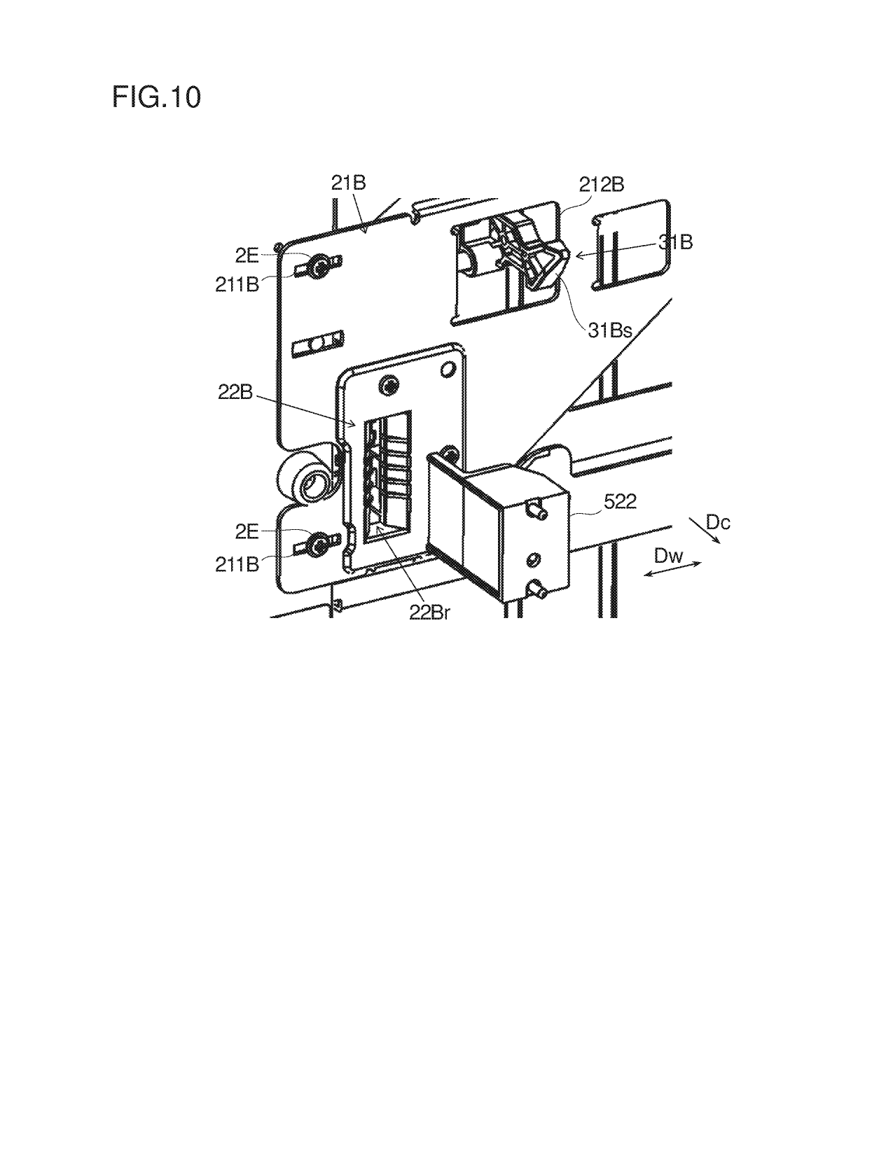

FIG. 8 is an enlarged view of the sensing portion 22B in the second position adjustment mechanism 20B in FIG. 6. FIG. 9 is an enlarged view of the inside of the sensing portion 22B in the second position adjustment mechanism 20B in FIG. 8. FIG. 10 is an enlarged view of the sensing portion 22B in the second position adjustment mechanism 20B in FIG. 8 and a sensing segment 522 in the image forming apparatus 501 to be inserted into the sensing portion 22B. Note that, in practice, the sensing segment 522 in the image forming apparatus 501 in FIG. 10 is provided in a side face (not shown) of the image forming apparatus 501.

The sensing portion 22B has a recessed part 22Br and a sensor 22Bs.

The recessed part 22Br is formed in a recessed shape that is recessed inward into the apparatus body 2 from one face of the second positioning member 21B parallel to the opposing face 2C. At a place on a side face of the image forming apparatus 501 opposite the sensing portion 22B, a sensing segment 522 (see FIG. 10) is provided that protrudes toward the sheet feeding apparatus 1. The recessed part 22Br is so shaped and sized that it can receive the sensing segment 522 on the side face of the image forming apparatus 501 when the sheet feeding apparatus 1 is coupled to the image forming apparatus 501.

As shown in FIG. 9, the sensor 22Bs is disposed inside the recessed part 22Br. The sensor 22Bs is configured as a contact-type or non-contact type sensor that recognizes the entry of the sensing segment 522 on the image forming apparatus 501 into the recessed part 22Br. In the embodiment, the sensor 22Bs is configured as a push-button switch. When the sheet feeding apparatus 1 is coupled to the image forming apparatus 501, the sensor 22Bs senses the sensing segment 522 on the image forming apparatus 501 making contact with it and pushed in it. The sensing signal from the sensor 22Bs is transmitted to the conveyance control portion 7. This allows the sensing portion 22B to sense the approach of the image forming apparatus 501 to the apparatus body 2.

The coupling mechanism 30B is fitted to the second positioning member 21B. Specifically, part of the coupling mechanism 30B is disposed at a front and a rear part of the opposing face 2C along the sheet width direction Dw, farther inside the apparatus body 2 than the second positioning member 21B.

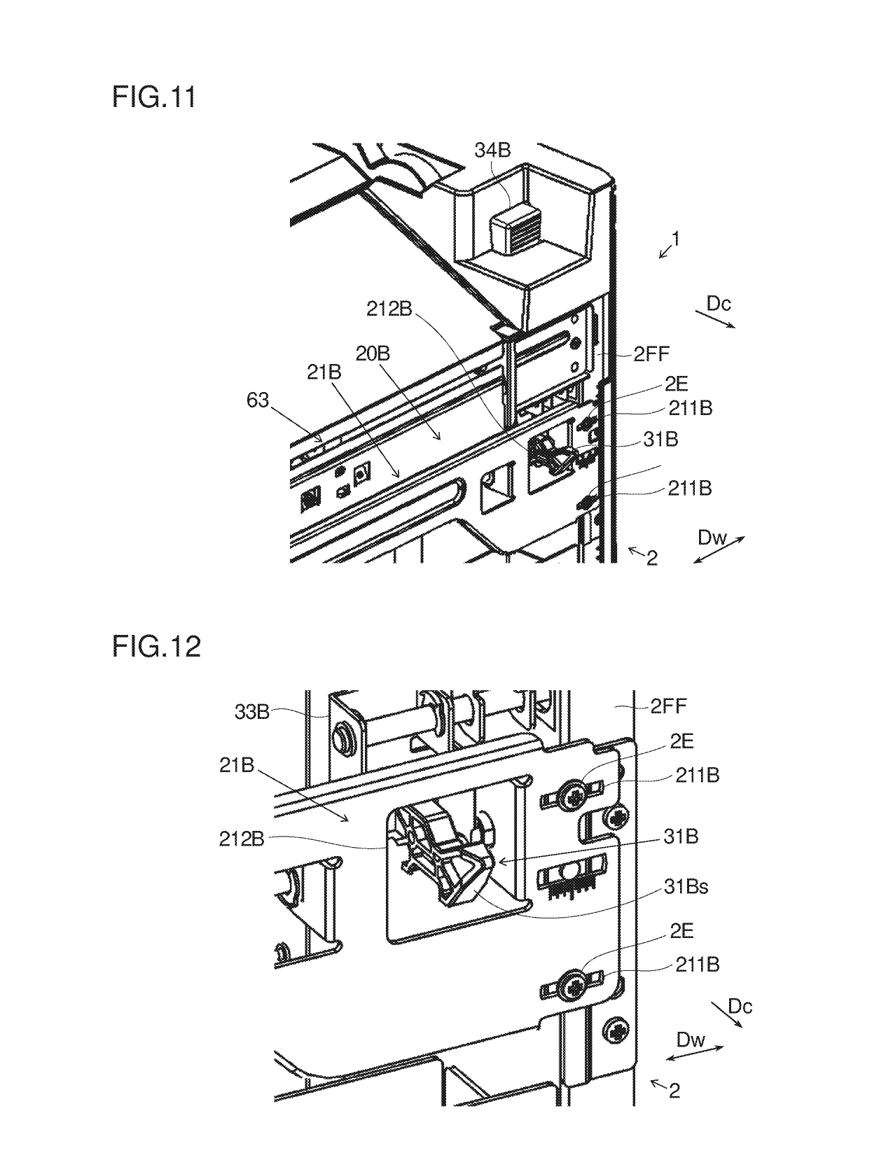

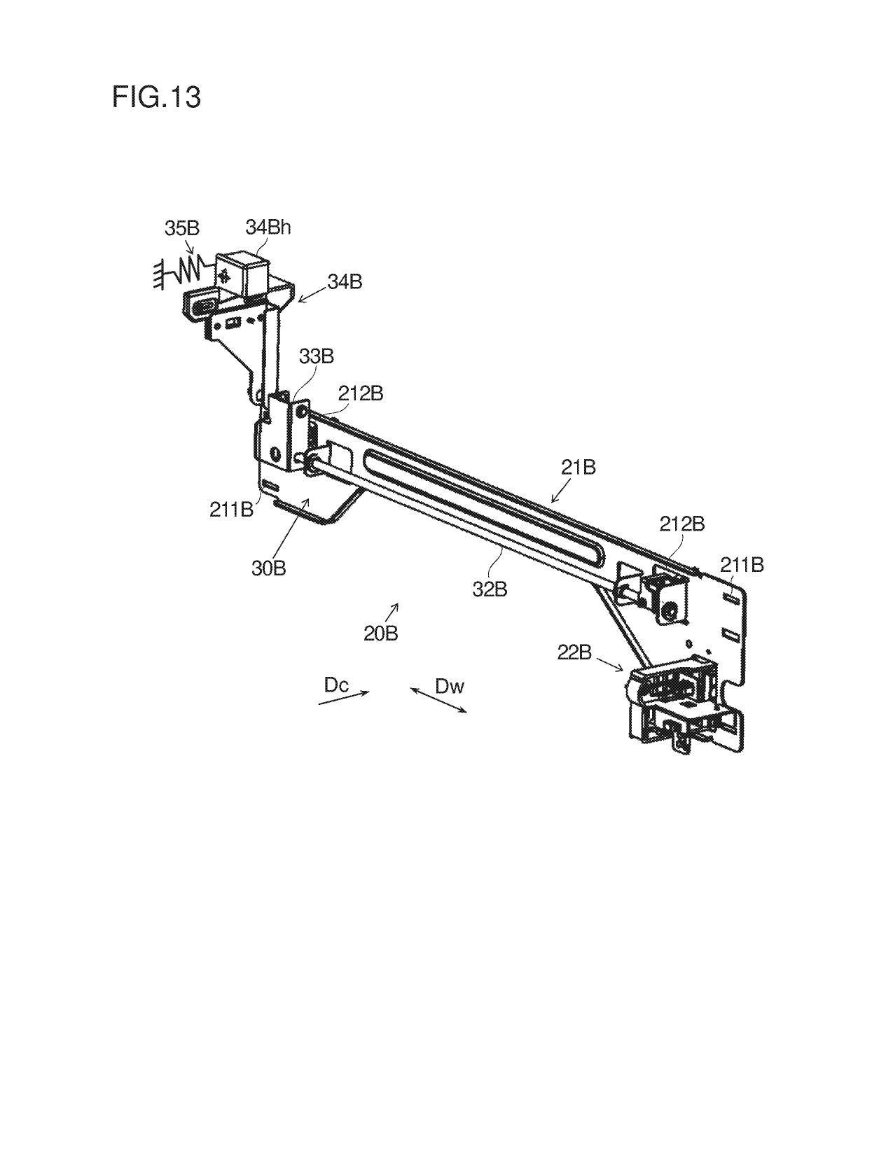

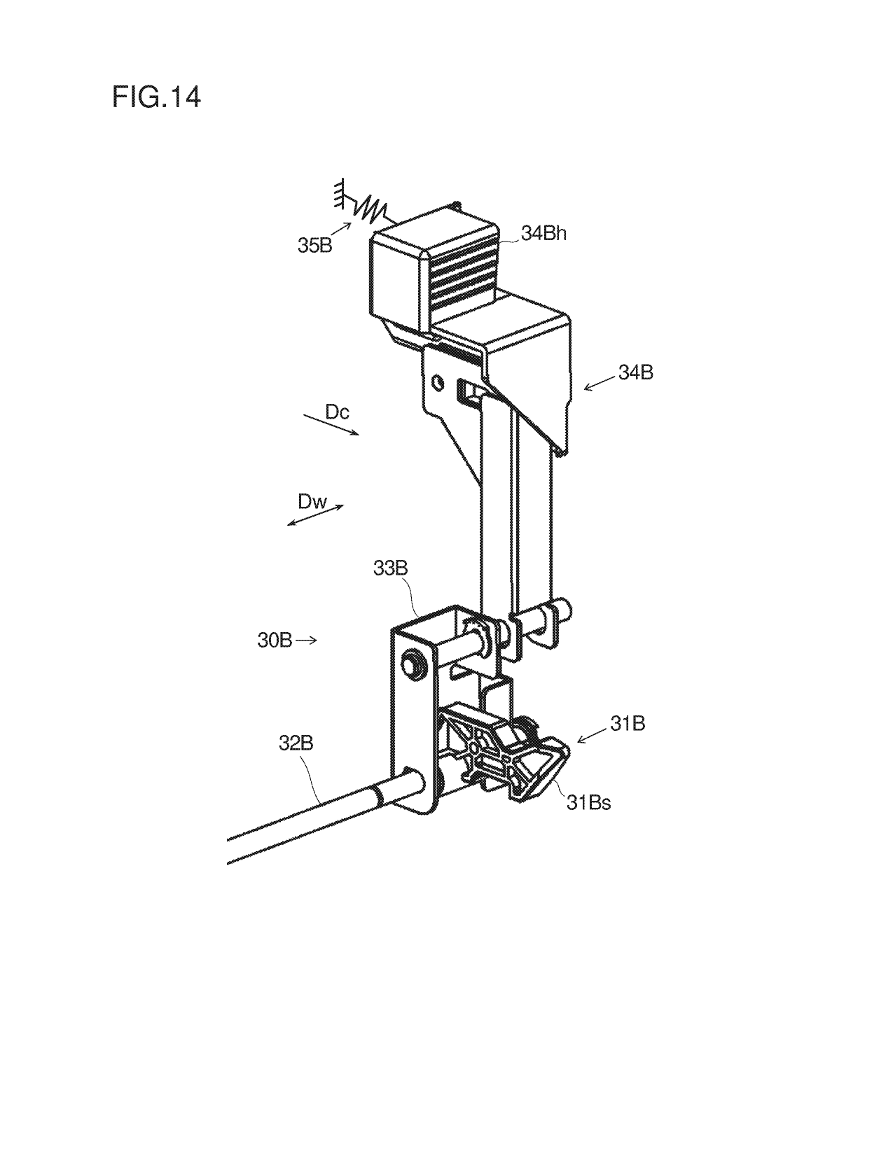

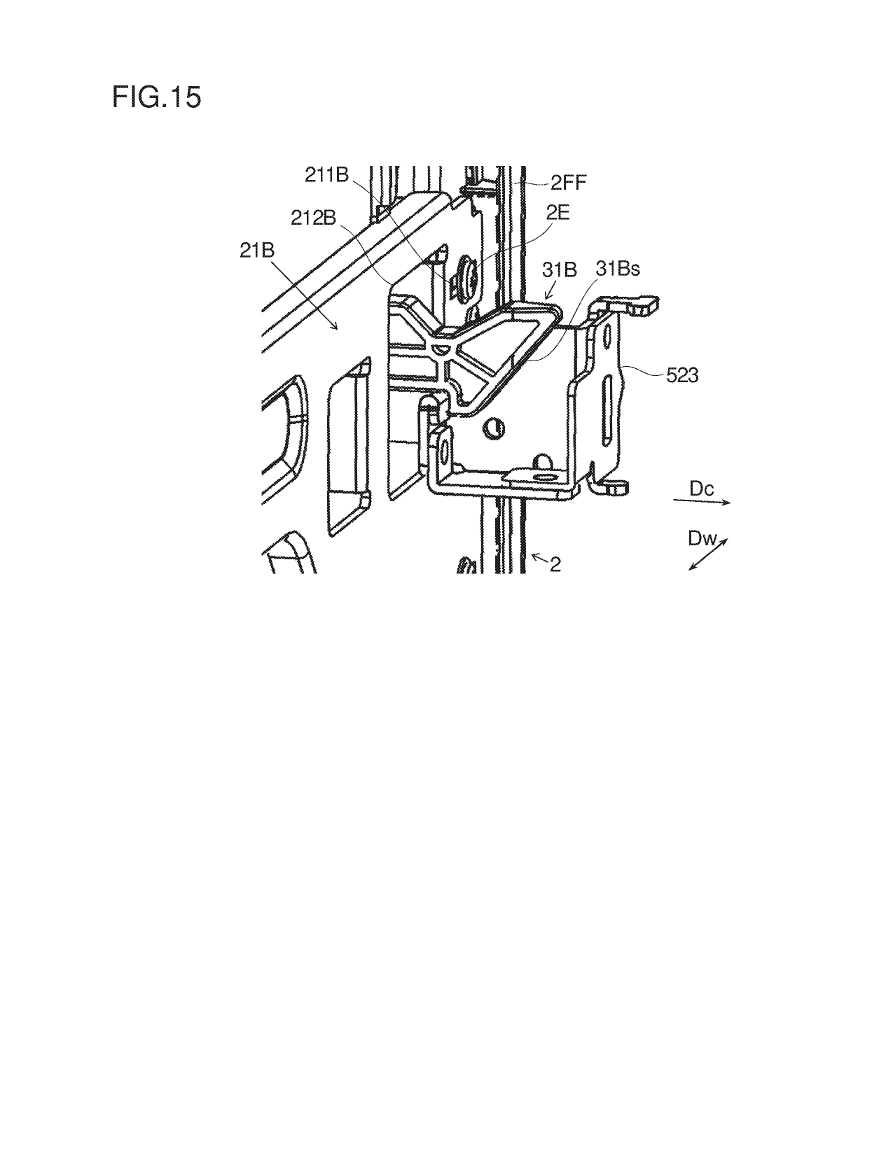

FIG. 11 is an enlarged view of a front part of the second position adjustment mechanism 20B in FIG. 6. FIG. 12 is an enlarged view of the hook member 31B in the second position adjustment mechanism 20B in FIG. 11. FIG. 13 is a perspective view, as seen from inside, of the second position adjustment mechanism 20B in FIG. 7. FIG. 14 is a perspective view of a lever member 34B and a link member 33B in the second position adjustment mechanism 20B in FIG. 13. FIG. 15 is an enlarged view of the hook member 31B in the second position adjustment mechanism 20B in FIG. 12 and a coupled portion 523 in the image forming apparatus 501 that couples to the hook member 31B. Note that, in practice, the coupled portion 523 in the image forming apparatus 501 in FIG. 10 is provided on the side face (not shown) of the image forming apparatus 501.

The coupling mechanism 30B includes a hook member 31B, a shaft 32B, a link member 33B, a lever member 34B, and an urging member 35B.

A pair of hook members 31B are disposed respectively at two places, specifically, at a front and a rear part of the opposing face 2C along the sheet width direction Dw. The second positioning member 21B has opening parts 212B, each in a rectangular shape that penetrates it along its thickness direction, respectively at places where the pair of hook members 31B are disposed. Part of the hook member 31B protrudes through the opening part 212B of the second positioning member 21B toward the image forming apparatus 501. A tip part of the hook member 31B that protrudes through the second positioning member 21B toward the image forming apparatus 501 is formed in the shape of a hook bent downward.

The pair of hook members 31B is fixed to the shaft 32B extending along the sheet width direction Dw inside the second positioning member 21B. The shaft 32B is supported on the second positioning member 21B so as to be rotatable about its own axis extending along the sheet width direction Dw. The shaft 32B couples the pair of hook members 31B together. That is, the hook members 31B are fitted to the second positioning member 21B so as to be swingable via the shaft 32B.

As shown in FIG. 15, the tip part of the hook member 31B has a slope face 31Bs formed on it that inclines downward as one goes from the image forming apparatus 501 toward the sheet feeding apparatus 1 (from right to left in FIG. 15). The side face of the image forming apparatus 501 has coupled portions 523 (see FIG. 15), each in a recessed shape that is recessed into the image forming apparatus 501, at places opposite the hook members 31B.

When the sheet feeding apparatus 1 approaches the image forming apparatus 501, the slope face 31Bs makes contact with the tip part of the coupled portion 523 in the image forming apparatus 501, so that the tip part of the hook member 31B is pushed upward along the inclination of the slope face 31Bs to hook on the tip part of the coupled portion 523. In this way, the hook member 31B is engaged with the image forming apparatus 501.

As shown in FIGS. 13 and 14, the link member 33B is disposed near the front-side hook member 31B of the second position adjustment mechanism 20B. The link member 33B is fixed to a front end part of the shaft 32B and extends outward along the radial direction of the shaft 32B. The link member 33B can rotate, together with the shaft 32B, about the axis of the shaft 32B extending along the sheet width direction Dw.

As shown in FIGS. 13 and 14, the lever member 34B is disposed near the front-side hook member 31B and the front-side link member 33B of the second position adjustment mechanism 20B. The lever member 34B is at its lower end coupled to the link member 33B, and extends along the top-bottom direction. The lever member 34B is supported on a slide portion (not shown) in the apparatus body 2 and is fitted so as to be reciprocatable along the sheet conveyance direction Dc in the sheet feeding apparatus 1 (along the directions in which it moves toward and away from the image forming apparatus 501).

In a top end part of the lever member 34B, an operation portion 34Bh is provided that a user can touch to operate the coupling mechanism 30B. Note that the lever member 34B is urged by the urging member 35B in a direction toward the image forming apparatus 501. A user can move the lever member 34B in a direction away from the image forming apparatus 501 by pushing, against the urging force of the urging member 35B, the operation portion 34Bh in a direction away from the image forming apparatus 501.

The lever member 34B, by moving with the urging force of the urging member 35B in a direction toward the image forming apparatus 501, rotates the shaft 32B about its own axis via the link member 33B to make the hook member 31B rotate and move to a position to couple with the coupled portion 523. In addition, the lever member 34B, by moving with the user’s operation in a direction away from the image forming apparatus 501, rotates the shaft 32B about its axis via the link member 33B to make the hook member 31B rotate and move to a position to decouple from the coupled portion 523.

As described above, operating the lever member 34B causes the coupling mechanism 30B to swing the pair of hook members 31B at the same time via the link member 33B and the shaft 32B. In that way, with the pair of hook members 31B, the coupling mechanism 30B couples and decouples the apparatus body 2 to and from the image forming apparatus 501.

Configured as described above, the sheet feeding apparatus 1 has, in its opposing face 2C facing the image forming apparatus 501 where it has the sheet feeding port 63 through which to feed the sheet S to the image forming apparatus 501, the position adjustment mechanism 20 that can adjust the position of the apparatus body 2 relative to the image forming apparatus 501 along the sheet width direction Dw. That is, along the sheet width direction Dw, the position of the sheet feeding port 63 of the sheet feeding apparatus 1 with respect to the image forming apparatus 501 can be adjusted appropriately. This makes it possible to suitably set the position at which the sheet feeding apparatus 1 feeds the sheet S to the image forming apparatus 501.

In addition, since the position adjustment mechanism 20 includes the first and second position adjustment mechanisms 20A and 20B, the position of the apparatus body 2 relative to the image forming apparatus 501 can be adjusted at two places, namely a lower part and a upper part, of the apparatus body 2. This helps avoid deformation or winding of the sheet conveyance path leading from the sheet feeding apparatus 1 to the image forming apparatus 501. This enhances the effect of suitably setting the position at which the sheet feeding apparatus 1 feeds the sheet S to the image forming apparatus 501.

In addition, since the first position adjustment mechanism 20A includes the first positioning member 21A and the slide member 22A, in coupling or decoupling the sheet feeding apparatus 1 to or from the image forming apparatus 501, the sheet feeding apparatus 1 can be moved along the long rail 521 in the image forming apparatus 501. This permits proper setting of the position of the sheet S and helps ease the operation to couple and decouple the sheet feeding apparatus 1 to and from the image forming apparatus 501.

In addition, since the second position adjustment mechanism 20B includes the second positioning member 21B, the sensing portion 22B, and the coupling mechanism 30B, when coupled and decoupled to and from the image forming apparatus 501, the sheet feeding apparatus 1 can sense its approach to the image forming apparatus 501 and can be coupled and decoupled to and from the image forming apparatus 501. Further, with the coupling mechanism 30B, the sheet feeding apparatus 1 can be engaged with the image forming apparatus 501 at the position of the second position adjustment mechanism 20B, that is, at a position near the sheet feeding port 63. This enhances the effect of suitably setting the position at which the sheet feeding apparatus 1 feeds the sheet S to the image forming apparatus 501.

In addition, since the coupling mechanism 30B includes the pair of hook members 31B arrayed along the sheet width direction Dw, the shaft 32B, and the lever member 34B, operating the lever member 34B causes the pair of hook members 31B to be swung at the same time about the axis of the shaft 32B. That is, operating the lever member 34B allows easy decoupling of the sheet feeding apparatus 1 from the image forming apparatus 501.

The embodiment of the present disclosure described above is not meant as any limitation on the scope of the present disclosure, which can thus be implemented with various modifications made without departing from the spirit of the present disclosure.

For example, while the above embodiment takes an image forming apparatus for monochrome printing as the image forming apparatus 501, it is not meant as any limitation to such models. The image forming apparatus can be, for example, an image forming apparatus for color printing.

What is claimed is:

1. A sheet feeding apparatus disposed beside an image forming apparatus and feeding a sheet as a recording medium to the image forming apparatus, the sheet feeding apparatus comprising:
an apparatus body in which the sheet is stacked and that is provided with a sheet feeding port through which the sheet is fed to the image forming apparatus, the sheet feeding port being disposed in an opposing face of the apparatus body facing the image forming apparatus; and
a position adjustment mechanism that is disposed at the opposing face of the apparatus body and that is capable of adjusting a position, along a sheet width direction orthogonal to a sheet conveyance direction, of the apparatus body relative to the image forming apparatus.

2. The sheet feeding apparatus according to claim 1, wherein
the position adjustment mechanism includes:
a first position adjustment mechanism disposed in a bottom part of the apparatus body; and
a second position adjustment mechanism disposed above the first position adjustment mechanism.

3. The sheet feeding apparatus according to claim 2, wherein
the image forming apparatus has a long rail having one end part thereof along the sheet conveyance direction connected to the image forming apparatus and extending along the sheet conveyance direction toward the apparatus body, and
the first position adjustment mechanism includes:
a first positioning member that is disposed along the opposing face of the apparatus body, the first positioning member being capable of adjusting an attachment position thereof, along the sheet width direction, with respect to the apparatus body; and
a slide member that is fixed to the first positioning member and that is capable of moving across the long rail along the sheet conveyance direction.

4. The sheet feeding apparatus according to claim 2, wherein
the second position adjustment mechanism includes:
a second positioning member that is disposed along the opposing face of the apparatus body, the second positioning member being capable of adjusting an attachment position thereof, along the sheet width direction, with respect to the apparatus body;
a sensing portion that is formed on the second positioning member and that senses of the image forming apparatus approaching the apparatus body; and
a coupling mechanism having a hook member fitted on the second positioning member so as to be swingable, the hook member being engageable with the image forming apparatus, the coupling mechanism swinging the hook member to couple and decouple the apparatus body to and from the image forming apparatus.

5. The sheet feeding apparatus according to claim 4, wherein
the coupling mechanism includes:
a plurality of the hook members disposed at a plurality of places along the sheet width direction;
a shaft that extends along the sheet width direction and that couples together the plurality of hook members; and
a lever member that rotates the shaft,
wherein
operating the lever member causes the plurality of hook members to swing at the same time to decouple the apparatus body from the image forming apparatus.

6. An image forming system comprising:
the sheet feeding apparatus according to claim 1; and
an image forming apparatus that is coupled to the sheet feeding apparatus and that forms an image on the sheet fed from the sheet feeding apparatus.
